(19) United States
(12) Patent Application Publication
(10) Pub. No.: US 2003/0009382 A1
(43) Pub. Date: Jan. 9, 2003

(54) Customer identification, loyalty and merchant payment gateway

(76) Inventors: Matthew A. D'Arbeloff, Boston, MA (US); Andrew Robbins, Newton, MA (US)

Correspondence Address: KENNETH F. KOZIK, Fish & Richardson P.C., 225 Franklin Street, Boston, MA, 02110-2804, US

(21) Appl. No.: 10/167,888

(22) Filed: Jun. 12, 2002

Related U.S. Application Data
(60) Provisional application No. 60/297,704, filed on Jun. 12, 2001.

(51) Int. Cl. G06F 17/60

(52) U.S. Cl. 705/17

(57) ABSTRACT

A method of handling electronic payments is provided. The method includes receiving an electronic payment request for a transaction from a user at a payment device, directing the payment request to a payment gateway, identifying and authenticating the user in the payment gateway, and routing the payment request to one of a number of payment networks.

### TECHNICAL FIELD

This invention relates to a customer identification, loyalty and merchant payment gateway system.

### BACKGROUND

In commerce, merchants act to sell goods and services and consumers act to purchase the goods and services. The purchase of the goods and services involves many different types of payment methods and devices. For example, merchants, and third parties offering the merchant's goods and services, receive payment through devices that accept credit cards, debit cards, Smart Cards and Radio Frequency Identification (RFID) tags. In each instance, a merchant installs specific hardware and software at every point of sale for the specific accepted payment method, costing the merchant for each installation of each specific device. At the same time, merchants selling goods and services are trying to increase their knowledge of a consumer's habits through the multitude of payment methods so that they can provide, for example, rewards and discounts, gather market research information and increase marketing effectiveness in a goal of breeding more loyal consumers.

In general, consumers have too many devices (e.g., phones, personal data assistants (PDAs), keys, and wallets), too many cards, and too many devices/cards to present at a point of purchase. Consumers spend too much time in checkout lines waiting for their payment to process or the payment processing ahead of them in line. Consumers desire simpler, faster, more convenient, and more flexible methods of payment and access to their loyalty rewards.

### SUMMARY

In an aspect, the invention features a method of handling electronic payments including receiving an electronic payment request for a transaction from a user at a payment device, directing the payment request to a payment gateway, identifying and authenticating the user in the payment gateway, and routing the payment request to one of a plurality of payment networks.

One or more of the following may be included. The payment request may be a credit card, debit card smart card, loyalty card and/or radio frequency identification (RFID) tag.

Identifying and authenticating the user may include loading a database in the payment gateway, determining whether an identification of the user is contained in the database, and determining whether the user's identification is authorized for the transaction. Routing may include loading a database in the payment gateway, loading a payment record of the user from the database, selecting the one of the plurality of payment networks according to the payment record.

The payment record may include a set of rules that indicate spending limits for the user, payment network selection for a given transaction size for the user, and additional required inputs from the user in conjunction with the payment request. The set of rules may be customizeable.

The method may also include loading a database, determining a merchant offering the transaction, and reporting the transaction to the merchant. Further, the method may include maintaining a report of the transaction, generating preferred payment information, and reporting and reconciling the payment request with the payment networks.

Routing the payment request to one of a plurality of payment networks may also include managing encryption keys in the payment gateway, managing card/device identification from a point of sale in the payment gateway, managing encrypted personal identification number (PIN) receipts and verification transactions in the payment gateway, and managing payment transactions to and from the payment networks in the payment gateway. The method may include maintaining a database in the payment gateway. The database may include a loyalty database including loyalty card Ids, names, addresses and phone numbers, a payment database including credit card information and bank account information, a payment history that is used by a set of rules to determine payment histories and detect fraud, and/or payment rules and personal identification number (PIN) encryption key management.

In another aspect, the invention features a system including a plurality of different type payment devices linked to a single payment gateway server, the gateway server configured to route payment requests to a plurality of different payment networks in accordance with rules contained in the gateway server.

One or more of following may be included. The payments devices may include credit card readers, debit card readers, smart card readers, loyalty card readers and/or radio frequency identification (RFID) tag devices. The rules may include security information, identification information, authorization information, spending limits for users, and payment network selections for given transaction sizes of users. The gateway server may include a database of user identification and authentication information, user payment history and user loyalty information.

The invention may have one or more of the following advantages.

The customer identification, loyalty and merchant payment gateway changes the way sellers of goods and services accept payment by separating an identification process of a buyer from a backend payment system.

The customer identification, loyalty and merchant payment gateway enables sellers to take control of the payment process, gain valuable information about their buyers, reduce payment costs and increase convenience of the purchase process with a goal of generating more loyal buyers.

By separating the process of validating a buyers' identity and authorizing the ability of buyers to pay for a transaction from the process of completing the backend transaction through a payment network, sellers can decide which payment devices to accept, without having to dramatically change their payment infrastructure.

The customer identification, loyalty and merchant payment gateway allows the seller to identify the buyer by whatever means they choose to accept (and the buyer chooses to present) and link a backend payment processing of that buyer with a pre-selected payment network.

The customer identification, loyalty and merchant payment gateway enables a seller of goods or services to better manage an identification of a buyer, authorize a purchase, deliver loyalty rewards or discounts, identify a preferred order/order-format, link to the buyer's preferred payment method, detect abnormal or fraudulent use, and process payments. The seller or buyer can be an individual, an individual representing an organization, an organization or a company.

The customer identification, loyalty and merchant payment gateway allows the buyer to be identified by any method mutually agreed to by the buyer and seller.

The customer identification, loyalty and merchant payment gateway allows use of debit or payment card for identification tied back to the same payment card account, but managing card and PIN information at the merchant to cut down on fraud, use as loyalty ID, reduced transaction time or reduced payment costs.

The customer identification, loyalty and merchant payment gateway allows use of debit or payment card for identification but performing the backend payment processing using a different payment card. For example, one could store my AMEX card information in a merchant's database but choose a VISA card for identification. When the consumer goes through the check out line at the merchant, the consumer presents a VISA card and the merchant gateway system charges an Amex card account for the transaction.

The customer identification, loyalty and merchant payment gateway allows the use of a Mobil Speedpass RFID tag to identify individuals, and, based on the user's payment preference, charging his/her bank account through an Automatic Clearing House (ACH) debit.

The customer identification, loyalty and merchant payment gateway allows use of loyalty card for identification of buyer (with or without a PIN, password or digital signature) and authorizing payment through a payment card, debit card, or ACH transaction.

The customer identification, loyalty and merchant payment gateway allows use of a cell phone or PDA for identification of buyer (with or without a PIN, password or digital signature) and authorizing payment through a payment card, debit card, or ACH transaction. In addition, the identification can be used to allow the buyer to participate in any loyalty program.

The customer identification, loyalty and merchant payment gateway allows use of a biometric device such as a fingerprint scan as identification of buyer and authorizing payment through a payment card, debit card, or ACH transaction.

A system where the loyalty or payment rules can be changed centrally through a browser interface and apply across all merchant stores without redeploying software to the point of sales system or payment terminal.

A system that employs a plurality of wallets per customer account.

A system that can attach multiple types of wallets including: stored value wallets, credit wallets, club program months, accrued points, accrued product points based on # items purchased of a specific SKU, accrued product points based on # items purchased within a product family, accrued product points based on # items purchased within a product category.

A system that can apply points based on the the physical weight, item price or some merchant defined index of an item, family of items or category of items.

A system that can apply loyalty rules in real-time including: point programs, frequency programs, club membership, birthday, web registration.

A system that can apply rules specific to a customer, merchant, time, date range and/or store number.

A system that can apply rules based on event type: point of sale loyalty request, web based request, time based event.

A system that can track and report on the use of rules specific in a payment or loyalty transaction.

A system that can reverse loyalty rules.

A system that allows the customer with an account to register one or more additional ID devices: credit card, loyalty card, phone number, user name and password, RFID device.

A system that allows the new ID device of 32 to be used for loyalty and payment transactions

A system that employs a flexible messaging structure between the point of sale system and the merchant payment gateway.

There is the ability to add or subtract information from messages.

There is the ability to change the definition of the messages. In other words, in credit card transactions they have fixed fields that always mean the same thing. In our messaging structure we have the ability to add and subtract fields to change the information that is exchanged between the point of sale and the merchant payment gateway and we can change the definitions of the fields.

There is the ability to add or change rules centrally and have the required changes in the messaging understood by the point of sale system and payment gateway without changing the software.

Other features, objects, and advantages of the invention will be apparent from the description and drawings, and from the claims.

### DESCRIPTION OF DRAWINGS

FIG. 1 is a block diagram of a network.

FIG. 2 is a block diagram of the customer identification, loyalty and merchant payment gateway server of FIG. 1.

FIG. 3 is a flow diagram of the merchant payment process of FIG. 2.

FIG. 4 is a flow diagram of a customer identification, loyalty and merchant payment gateway process.

### DETAILED DESCRIPTION

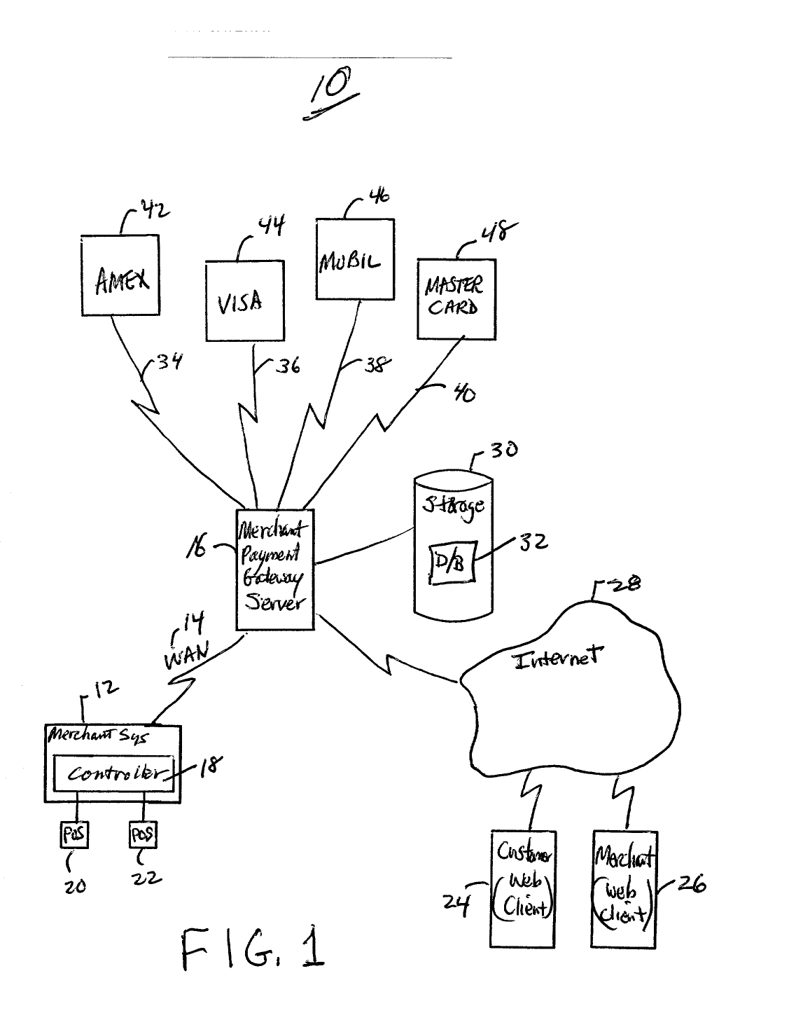

Referring to FIG. 1, a network 10 includes a merchant's computer system 12 linked via a Wide Area Network (WAN) 14 to a customer identification, loyalty and merchant payment gateway server 16. The computer system 12 includes a controller 18 linked to point of sale payment input devices 20, 22. Example point of sale payment input devices are credit card readers, debit/ATM card readers, Smart Card readers and Radio Frequency Identification (RFID) tag readers. Input from the point of sale input devices 20, 22 is received by the controller 18 and sent via the WAN 14 to the customer identification, loyalty and merchant payment gateway server 16. The controller 18 manages messaging between the host 16 and a correct point of sale input device 20, 22. The controller 18 also monitors network connectivity. While the network 10 is down, the controller 18 messages and reduces point of sale functionality. For example, during failed network conditions, the controller 18 may not allow redemptions but may allow adding points or money. When the network 10 comes back up, the controller 18 stores and forwards allowable transactions and auto uploads the information to the host 16 at a later time.

The networks 10 includes a consumer system 24 and a merchant system 26 linked to the customer identification, loyalty and merchant payment gateway system 16 through the Internet 28. Payment information received from a user (not shown) on the customer system 24 is transmitted to the customer identification, loyalty and merchant payment gateway system server 16 via the Internet 28. Input received from a user (not shown) on the merchant system 26 is transmitted to the customer identification, loyalty and merchant payment gateway system 16 via the Internet 28.

The customer identification, loyalty and merchant payment gateway system 16 includes a local storage device 30 storing a database 32. The customer identification, loyalty and merchant payment gateway system 16 also includes multiple links 34, 36, 38, 34 to respective payment networks 42, 44, 46, 48.

The customer identification, loyalty and merchant payment gateway server 16 is flexible and may be connected to any payment network and any point of sale payment device connected to a controller. As is described below, the customer identification, loyalty and merchant payment gateway server 16 uses a given payment device, e.g., payment device 20, to authenticate an identity of a buyer and coordinate payment processing through the preferred payment network 42, 44, 46 or 48. The customer identification, loyalty and merchant payment gateway server 16 uses a pay database 32 to approve a buyer's purchases, making response time greater than seeking approval from one of the payment networks 42, 44,46,48.

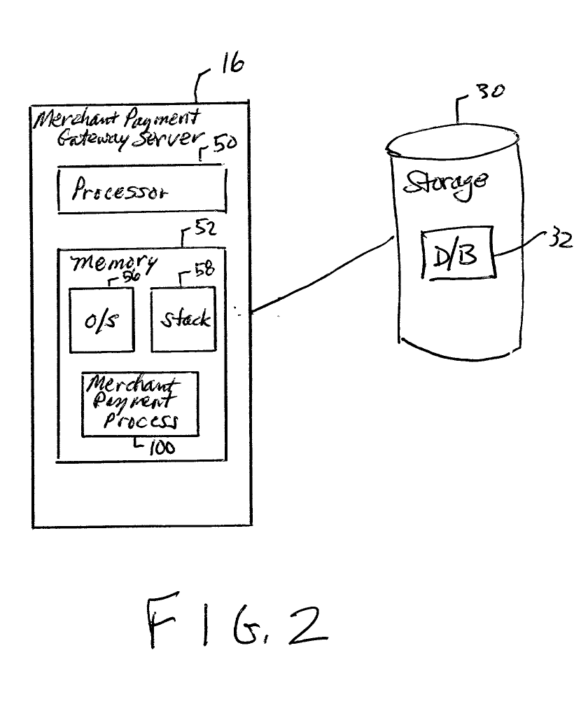

Referring to FIG. 2, the customer identification, loyalty and merchant payment gateway server 16 includes a processor 50, a memory 52, and the storage device 30. Memory 52 includes an operating system (O/S) 56, such as Linux or Microsoft Windows XP, a TCP/IP stack 58 for interacting with the Internet 28, and instructions to execute a merchant payment process 100.

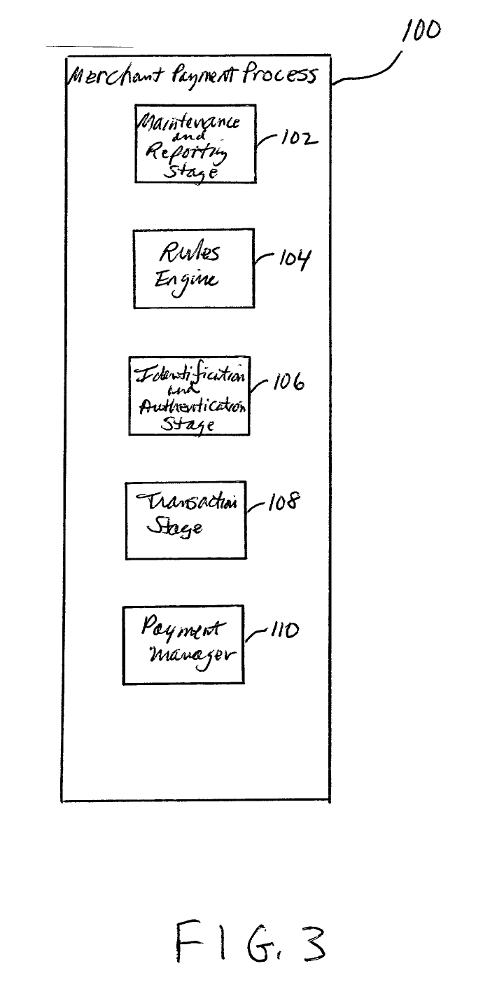

Referring to FIG. 3, the merchant payment process 100 includes a maintenance and reporting stage 102, a rules engine 104, an identification and authentication stage 106, a transaction stage 108 and a payment manager 110.

The maintenance and reporting stage 102 is responsible for the maintenance of the customer identification, loyalty and merchant payment gateway server 16 and preparing transaction reports. A seller is given complete and accurate reporting because all payment transactions in the network 10, independent of the customer contact point and payment network, pass through the merchant gateway server 16, and specifically the merchant payment process 100. More specifically, the maintenance and reporting stage 102 manages generation of preferred payment information, reset of preferred payment information, reporting and reconciliation of payments with payment networks 42, 44, 46, 48, and reporting and reconciliation of payments with an Enterprise Resource Planning (ERP) system (if installed).

The rules engine 104 allows a seller to customize how the merchant payment process 100 handles their specific needs and the needs of their customers. For example, the rules engine 104 may be used to implement spending limits for individual customers, select different payment networks 42, 44, 46, 48 for given transaction sizes, or to require a buyer to enter a Personal Identification Number (PIN) if a transaction is over a selected amount. More specifically, the rules engine 104 executes in conjunction with a set of rules stored in the database 32. The rules are callable by name, can be added, deleted and modified, chained together and customized (e.g., regional specific rules). The rules are real-time in that they are loaded for the card and merchant and run real-time. The rules are not embedded in code or stored procedures.

The identification and authorization stage 106 handles an identification of a buyer through a payment device and authorization of a transaction. To do this the identification and authorization stage 106 communicates with the database 32 that stores a buyer's identification number, preferred payment information, and payment history. The payment database 32 includes multiple databases of information. For example, to increase security the PIN information is stored in encrypted form on a separate database from a person's name, phone number, and payment account information. The identification and authorization stage 106 matches the identification number with the identification number taken from the payment device to confirm the buyer's identity and analyzes the buyer's payment history, looking for irregularities or past credit problems, to authorize the transaction. In the event of a transaction using a PIN, the identification and authorization stage 106 communicates with a secure PIN manager (not shown), such as Compaq's Attalla A10000PCI or Thales' HSM7100, which in turn verifies the PIN information with an encrypted PIN database.

The transaction layer stage 108 communicates between the other stages 102, 104, 106, 110 and the customer contact points of sale (e.g., POS 20, POS 22, customer system 24), relaying information about a transaction, identification, authorization, and PIN. In an embodiment, the transaction layer stage 108 uses independent links (not shown) to connect to customer contact points of sale. The transaction layer stage 108 interfaces with information contained in the database 32, such PIN and key information, payment and other databases. More specifically, the transaction layer stage 108 handles encryption key management, card/device identification from a point or sale, encrypted PIN receipt and verifications transactions, and authorization requests to payment networks 42, 44, 46, 48. Further, the transaction layer stage 108 handles authorization results from payment networks 42, 44, 46, 48, authorization results back from a point of sale, payment transactions to and from payment networks 42, 44, 46, 48, and account maintenance originating from web, phone and store.

The payment manager stage 110 provides for direct access to the payment networks (e.g., Visa or other payment card networks, ATM, ACH, or other networks), and allows for the use of an electronic wallet. An electronic wallet is a small software program used for online purchase transactions. Many payment solution companies, such as CyberCase, offer free Wallet software that allows several methods of payment to be defined within the wallet (for example, several different credit cards). This allows the system to handle pre-paid account programs such as stored-value cards and accounts that automatically draw down a set amount from the buyer when his/her account approaches zero. More specifically, the payment manager stage 110 verifies payment information with payment networks 42, 44, 46, 48 and third party databases (not shown), correction of payment information, manage authorization, pre-authorization and transactions with payment networks 42, 44, 46, 48, and provides an ability to add a wallet, stored value or gift card functionality.

The transaction layer stage 108 and the payment manager stage 110 allow a seller to insert new payment networks, customer contact points, and payment devices without changing the configuration of the customer identification, loyalty and merchant payment gateway server 16.

The database 32, as discussed above, may contain multiple databases. For example, the database 32 may contain a loyalty database containing loyalty card IDs, names, addresses and phone numbers. The database 32 may include a payment database containing credit card information and bank account information. The database 32 may include a payment history that can be used by the rules engine 104, for example, for fraud detection. The database 32 may also include payment rules and PIN encryption key management.

To more fully illustrate the merchant payment process 100, two examples are now presented.

Loyalty Card Payment Example

Merchants use loyalty cards as a way to identify consumers. In general, a loyalty cards is card issued by a merchant to identify the buyer as part of a loyalty rewards program. A loyalty rewards program is a program offered by a seller or merchant that rewards buyers for their patronage to increase buyer loyalty. Reward programs may include product discounts and coupons, points associated with a purchase that can be used at the store or other places like frequent flyer miles, special offers, invitations to special events or rebates tied to purchases. A loyalty card given to the buyer usually has the merchants name printed on the card and a unique account number stored on the card, often utilizing a bar code or magnetic stripe.

Loyalty cards typically contain a unique identification number that the merchants loyalty reward program uses to track the buyer's purchases. To allow quick input of the identification number these cards usually contain some type of export device such as a barcode or magnetic stripe. When a customer gets to the point-of-sale terminal 20, he or she will either swipe the card through a magnetic card reader or scan the card with a bar code-scanning device. Depending on the level of security desired by the seller, the seller could also require the buyer to enter a PIN into an input device, which would be encrypted at the terminal. The information is transmitted through the controller 18 over the WAN 14 to the merchant payment process 100 of the customer identification, loyalty and merchant payment gateway system 16. The process 100 uses the pay database 32 to confirm the buyer's identification number and PIN, and authorize the transaction. The pay database 32 sends the appropriate transaction data and identification number to a loyalty database, thus allowing the buyer to benefit from the buyer loyalty program. Once the transaction is authorized, the process 100 informs the POS terminal 20 to allow the transaction to proceed and perform the backend payment processing with a payment network that was pre-selected by the buyer.

Payment Card or Debit Card Used as a Loyalty Card

The average buyer already has a number of cards in his/her wallet including a driver's license, multiple payment cards and membership cards. Sellers are also asking buyers to carry additional loyalty cards (e.g. grocery stores, drug stores, restaurants, coffee shops, movie rental stores, airlines, hotel chains, etc.). However, for many transactions buyers have a preferred method of payment (e.g. when buying gas, I use my Visa card; when grocery shopping, I use my debit card; when clothes shopping, I use my American Express). The merchant payment process 100 is used to identify a buyer for a loyalty program when a payment card or debit card is presented. The loyalty reward program then knows to give the consumer the appropriate rewards, and the consumer would not have to present a separate card.

A consumer may specifically state his/her wish to be part of a loyalty rewards program and to use his/her payment or debit card as an identifier for the loyalty program. In addition, the merchant payment process 100 keeps the consumers card number private. Specifically, once the consumer's payment or debit card is swiped in the magnetic card reader, or entered by some manner, the merchant payment process 100 encrypts the card's number using a one-way encryption algorithm. Passing it through the customer contact point, the merchant payment process 100 sends the encrypted PIN to an identification database that matches the encrypted number to the buyer's loyalty identification number. The buyer's loyalty identification number is then sent to the loyalty database, which interacts with the customer contact point to allow the buyer to participate in the seller's loyalty program. At no point in this process is the buyer's card number stored in an unencrypted form. Even if the identification database is compromised, the most information an unauthorized user could access would be the buyer's encrypted card number (which could not be unencrypted to reveal the actual card number) and the buyer's loyalty identification number, neither of which could be used for payment. In a situation where security is not a significant concern, the card can be stored unencrypted.

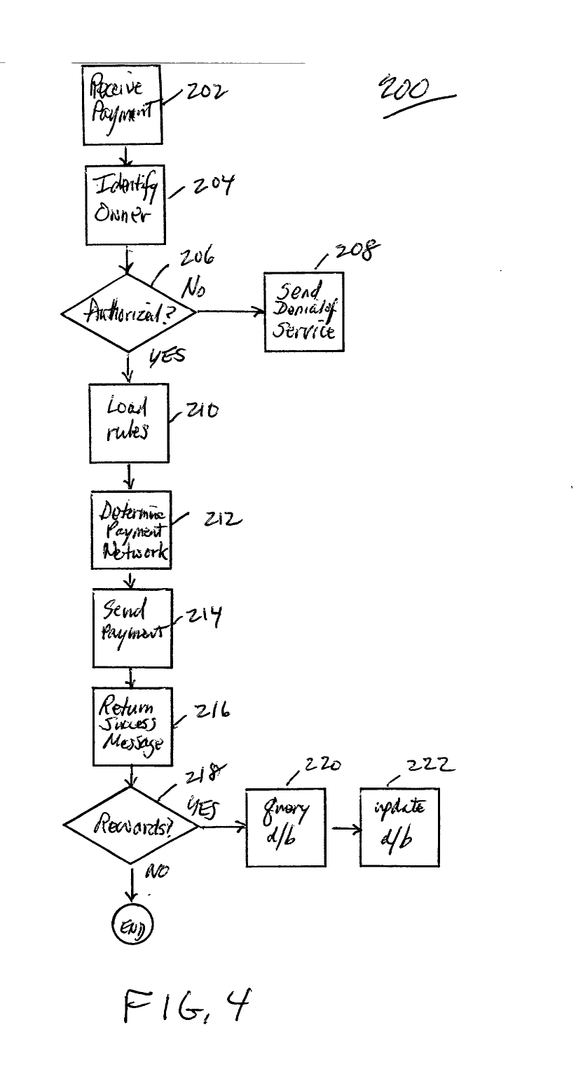

Referring to FIG. 4, a customer identification, loyalty and merchant payment gateway process 200 includes receiving (202) a payment via a point of sale input device. The process 200 identifies (204) an owner of the payment and determines (206) if the owner is authorized to make the payment. If the owner is not authorized to make the payment, the process 200 sends (208) and denial of service message to the point of sale device. If the owner is authorized to make the payment, the process 200 loads (210) a set of rules and determines (212) a payment network selected by the user. The process 200 sends (214) payment to the appropriate payment network and returns (216) a success message to the user. The process 200 determines (218) whether the user is participating in a loyalty program. If the user is participating in a loyalty program, a historical database is queried (220) and updated (222) with the appropriate transactional information.

Other embodiments are within the scope of the following claims.

What is claimed is:

1. A method of handling electronic payments or electronic loyalty program comprising:
receiving an electronic loyalty or payment request for a transaction from a user at a payment point of sale device;
directing the loyalty or payment request to a payment gateway;
identifying and authenticating the user in the payment gateway; applying rules specific to the customer, merchant, store and time and
routing the loyalty or payment request to an internal loyalty or payment program stored value or in-house charge and/or to one of a plurality of loyalty and/or payment networks.

2. The method of claim 1 in which the payment request is a credit card.

3. The method of claim 1 in which the payment request is a debit card.

4. The method of claim 1 in which the payment request is smart card.

5. The method of claim 1 in which the payment request is a loyalty card.

6. The method of claim 1 in which the payment request is a radio frequency identification (RFID) tag.

7. The method of claim 1 in which identifying and authenticating the user comprises:
loading a database in the payment gateway;
determining whether an identification of the user is contained in the database; and
determining whether the user's identification is authorized for the transaction.

8. The method of claim 1 in which routing comprises:
loading a database in the payment gateway;
loading a payment record of the user from the database;
selecting the one of the plurality of payment networks according to the payment record.

9. The method of claim 8 in which the payment record comprises a set of rules that indicate spending limits for the user, payment network selection for a given transaction size for the user, and additional required inputs from the user in conjunction with the payment request.

10. The method of claim 9 in which the set of rules are customizeable.

11. The method of claim 1 further comprising:
loading a database;
determining a merchant offering the transaction; and
reporting the transaction to the merchant.

12. The method of claim 11 further comprising:
maintaining a report of the transaction;
generating preferred payment information; and
reporting and reconciling the payment request with the payment networks.

13. The method of claim 8 in which routing the payment request to one of a plurality of payment networks further comprises:
managing encryption keys in the payment gateway;
managing card/device identification from a point of sale in the payment gateway;
managing encrypted personal identification number (PIN) receipts and verification transactions in the payment gateway; and
managing payment transactions to and from the payment networks in the payment gateway.

14. The method of claim 1 further comprising maintaining a database in the payment gateway.

15. The method of claim 14 in which the database comprises a loyalty database including loyalty card Ids, names, addresses and phone numbers.

16. The method of claim 14 in which the database comprises a payment database including credit card information and bank account information.

17. The method of claim 14 in which the database comprises a payment history that is used by a set of rules to determine payment histories and detect fraud.

18. The method of claim 14 in which the database comprises payment rules and personal identification number (PIN) encryption key management.

19. A system comprising:
a plurality of different type payment devices linked to a single gateway server, the gateway server configured to route payment requests to a plurality of different payment networks in accordance with rules contained in the gateway server.

20. The system of claim 19 in which the payments devices include credit card readers, debit card readers, smart card readers, loyalty card readers and radio frequency identification (RFID) tag devices.

21. The method of claim 19 in which the rules comprise security information, identification information, authorization information, spending limits for users, and payment network selections for given transaction sizes of users.

22. The system of claim 19 in which the gateway server includes a database of user identification and authentication information, user payment history and user loyalty information.

23. The system of claim 19 in which the rules are loyalty or payment rules that can be changed centrally through a browser interface and apply across all merchant stores without redeploying software to the point of sales system or payment terminal.
